(19) United States
(12) Patent Application Publication
(10) Pub. No.: US 2006/0220836 A1
(43) Pub. Date: Oct. 5, 2006

(54) Interactive e-map surveillance system and method

(75) Inventors: Shou-Kang Wei, Chung Ho City (TW); Mao-Cheng Wu, Chung Ho City (TW)

Correspondence Address: LOWE HAUPTMAN BERNER, LLP, 1700 DIAGONAL ROAD, SUITE 300, ALEXANDRIA, VA, 22314, US

(73) Assignee: AverMedia Technologies, Inc., Chung Ho City (TW)

(21) Appl. No.: 11/206,208

(22) Filed: Aug. 18, 2005

(30) Foreign Application Priority Data
Mar. 31, 2005 (TW) 94110327

(51) Int. Cl. G08B 1/00

(52) U.S. Cl. 340/539.2

(57) ABSTRACT

An interactive e-map surveillance system is described. The surveillance system includes a screen, a host, and a selection device. The screen displays a map and a plurality of monitoring locations. When one of the monitoring locations detects a specific event, the host shows emergence messages on the screen. When the specific event is detected and the selection device is activated, the surveillance system automatically informs units in charge of the specific event.

### RELATED APPLICATIONS

The present application is based on, and claims priority from, Taiwan Application Serial Number 94110327, filed Mar. 31, 2005, the disclosure of which is hereby incorporated by reference herein in its entirety.

### BACKGROUND

1. Field of Invention

The present invention relates to a surveillance system and method. More particularly, the present invention relates to an interactive e-map surveillance system and method.

2. Description of Related Art

Various surveillance systems are widely applicable to streets, houses, factories, airports, ports and stations recently. For the streets and houses, the surveillance system is capable of preventing the occurrence of a crime or finding out a reason of the occurrence of an accident after the accident is occurred. For the factories, airports, ports and stations, in addition to prevent the crime to be occurred, the surveillance system also can ensure the public security. When an accident is occurred, the surveillance system may detect the accident at once so as to provide a better process to take care of the accident.

The conventional surveillance system usually can only provide a monitoring screen, when an accident is occurred, however, no matter to inform units in charger of the rescue, describe the scene of the accident or make an emergency measure which rely on the manpower and thereby easily result in the process of the rescue to be delayed. There are some systems such as a fire alarm that can only provide an alarm ringing or a light glitter corresponding to a fire area, however, they cannot provide a process to take care of the fire or more information relating to the fire.

Accordingly, in order to solve the above problems, a novel surveillance system that can provide urgent emergency information and make an emergency measure so as to reduce the time used to cope with the urgent event is needed.

### SUMMARY

It is therefore an objective of the present invention to provide an e-map surveillance system and method, which is able to provide urgent emergency messages for a specific event when the specific event is occurred.

It is another objective of the present invention to provide an e-map surveillance system and method, which is able to automatically inform a responsible unit when a specific event is occurred.

It is still another objective of the present invention to provide an e-map surveillance system and method, which is able to automatically turn on the emergency equipment when a specific event is occurred.

According to the foregoing objectives of the invention, the present invention provides an e-map surveillance method. According to a preferred embodiment of the present invention, the e-map surveillance method comprises the steps of displaying a map and a plurality of monitoring locations on a screen, wherein the map is corresponding to a monitored area, displaying emergency messages of a specific event on the screen when one of the monitoring locations detects the specific event, and automatically informing a unit in charge of the specific event.

The emergency messages of the specific event include, for example, a name of the unit, a method of communication and useful equipment. When the specific event is detected by the monitoring location, the corresponding emergency equipment such as a lock, a fire extinguisher, lighting or a power could be activated automatically.

According to the objectives of the invention, the present invention provides an interactive e-map surveillance system. According to a preferred embodiment of the present invention, the interactive e-map surveillance system comprises a screen, a host and a selection device. The screen displays a map and a plurality of monitoring locations, wherein the map is corresponding to a monitored area. The host shows emergency messages of a specific event on the screen when the specific event is detected by one of monitoring locations. The surveillance system informs a unit in charge of the specific event when the specific event is detected by one of monitoring locations and the selection device is activated.

The present invention at least includes the following advantages, wherein each embodiment includes one or more advantages. The interactive e-map surveillance system and method of the present invention is able to provide urgent emergency messages for each specific event. When a specific event is occurred, the interactive e-map surveillance system is able to automatically inform the responsible units. When a specific event is occurred, the interactive e-map surveillance system and method of the present invention is able to automatically turn on the emergency equipment.

It is to be understood that both the foregoing general description and the following detailed description are by examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of a preferred embodiment of the present invention;

FIG. 2 is a schematic diagram of a preferred embodiment of the present invention;

FIG. 3 is a schematic diagram of an e-map of a preferred embodiment of the present invention; and

FIG. 4 is a schematic diagram of a surveillance system of a preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

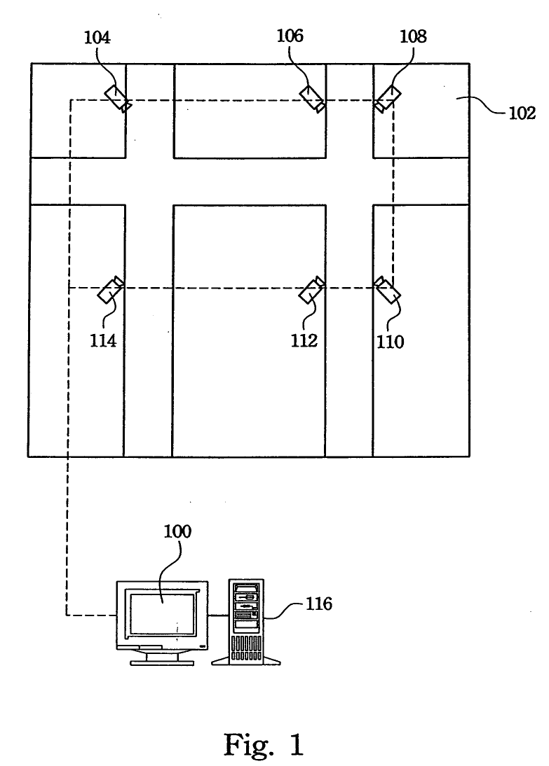

FIG. 1 is a schematic diagram of a preferred embodiment of the present invention. Referring to FIG. 1, which shows an e-map surveillance system. The surveillance system includes a host 116 and a screen 100. The steps of an e-map surveillance method of the present invention includes displaying a map 102 and a plurality of monitoring locations 104, 106, 108, 110, 112 and 114 on the screen 100, wherein the map 102 corresponds to a monitored area. When one of the monitoring locations detects a specific event, the host 116 shows emergency messages of the specific event on the screen 100 and then automatically informs a unit in charge of the specific event.

FIG. 1 corresponds to a street map. These monitoring locations 104, 106, 108, 110, 112 and 114 are, for example, cameras distributed to the street. Each camera is used to monitor a monitoring area around the camera. These monitoring locations 104, 106, 108, 110, 112 and 114 are connected to the host 116 via a network so as to communicate each other. The host 116 controls the surveillance system and the determination and communication of the messages thereof.

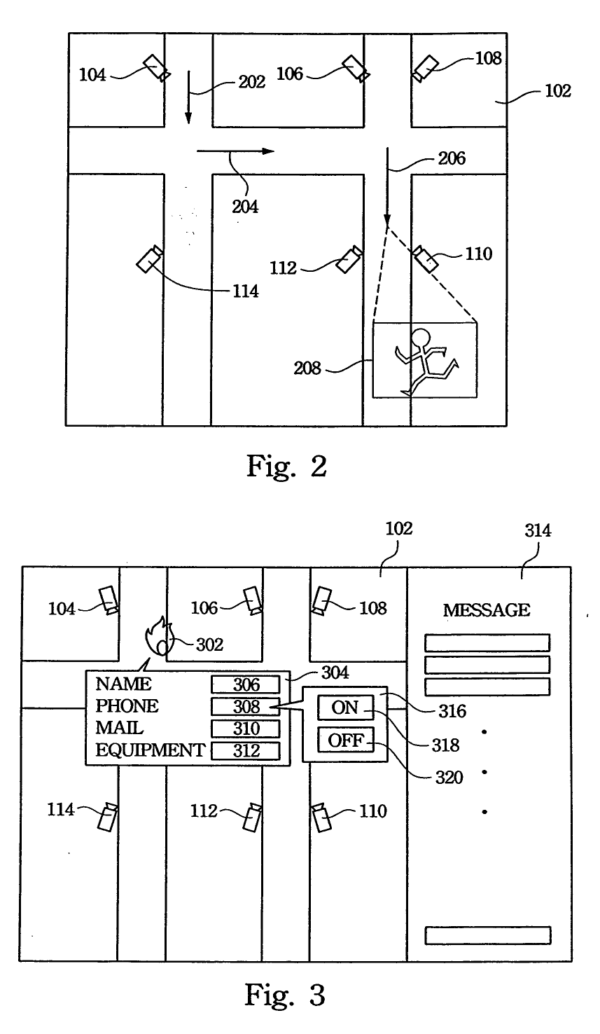

FIG. 2 is a schematic diagram of a preferred embodiment of the present invention. Referring to FIG. 2, a specific event is an invader appearing, for example. The camera 104 tracks and captures the invader. Direction 202 represents an escape direction for the invader. When the invader approaches the monitoring location 114, the camera 104 informs the monitoring location 114 to keep monitoring the invader. Then, the invader turns his/her escape direction to a direction 204. At this time, the surveillance system informs the monitoring locations 106 and 108 to keep monitoring the invader. If the invader turns his/her escape direction to a direction 206 again, the surveillance system informs the monitoring locations 112 and 110 to keep monitoring the invader.

These monitoring locations 104, 106, 108, 110, 112 and 114 are, for example, the PTZ cameras, which are able to rotate and slope toward various directions so as to keep tracking the invader. The host 116 is connected to these monitoring locations via a network so as to communicate each other; therefore, these monitoring locations are able to keep tracking the invader mobility.

When the invader is appeared, the screen is able to promptly show a sub-screen 208 and display a picture captured by the camera 110 most closed to the invader. The surveillance system not only can view whole monitoring areas by the map 102 but also can instantly view a detailed image of the invader by the sub-screen 208.

FIG. 3 is a schematic diagram of an e-map of a preferred embodiment of the present invention. For example, a specific event such as fire is occurred on the location 302. The surveillance system may immediately show an emergency message 304 of the specific event on the map 102, wherein the emergency message 304 includes but not limited to a name 306 in charge of the specific event, a method of communication 308, 310 and useful equipment 312. The surveillance system can provide an enough instant message to a guarder and a disaster rescuer. In addition, an emergency message 314 could be disposed on an edge of the map 102 for providing more messages related to the specific event such as a type of fire, a type of chemical and a variation of surroundings temperature, etc.

When a specific event is occurred, the surveillance system may automatically turn on emergency equipment corresponding to the specific event. For example, when an invader is appeared, the surveillance system may automatically turn off all locks around the passages. When a fire is occurred, the surveillance system may automatically turn on all fire extinguishers and turn off all powers around the fire area. When a specific event is occurred in the night, the surveillance system may automatically turn on lighting.

The surveillance system may also automatically dial to a responsible unit or may automatically send out a warning message and an e-mail, for example, to inform a fire brigade to rescue. The surveillance system may also display a warning message on a screen, for example to send out an alarm ringing or show a glittering picture on the map.

In another embodiment, the surveillance system could be designed to have an interactive architecture. For example, a selection device 316 is provided near the emergency message 304. When a monitoring location detects a specific event, a user is able to select whether to turn on emergency equipment corresponding to the specific event. For example, when the selection device 316 is turned on, for example to push down a picture of button ON 318, the surveillance system automatically informs units in charge of the specific event. When a picture of button OFF 320 is pushed down, the surveillance system ignores the specific event.

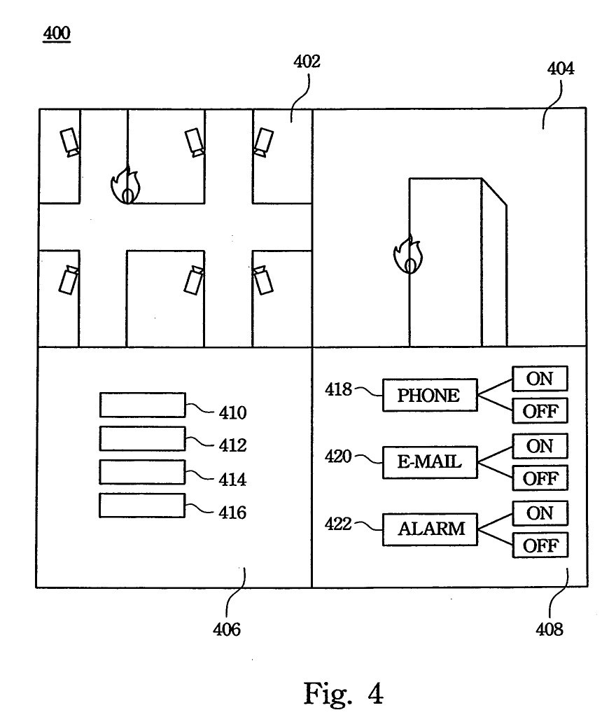

FIG. 4 is a schematic diagram of a surveillance system of a preferred embodiment of the present invention. Referring to FIG. 4, a picture 400 on the screen is divided into four regions including a map region 402, a live image region 404, an emergency message region 406 and a response region 408. The map region 402 provides an entire map and the position of all monitoring locations. The live image region 404 provides a live image, such as a picture showing a live fire. The emergency message region 406 provides emergency messages concerning a specific event such as a fire. For example, the emergency messages include a temperature 410 on the fire area, a corresponding chemical material 412, necessary equipment 414 and a name 416 of the responsible person. The response region 408 is used to provide a number of corresponding responses for a guarder to choice. For example, the corresponding responses include whether to dial 418, whether to send out an e-mail 420 and whether to send out an alarm message 422. The guarder is able to use the buttons ON and OFF on the screen to make a decision and carry out a corresponding action.

The surveillance system of the present invention is applicable to the places in need of monitor and urgent disaster emergency measure such as factories, streets, stores, airports, ports and stations. The surveillance system not only can monitor and record but also can provide various policies and automatic measure, so that the time of response can be decreased and the effect of urgent emergency can be enhanced.

The present invention at least includes the following advantages, wherein each embodiment includes one or more advantages. The interactive e-map surveillance system and method of the present invention is able to provide urgent emergency message for each specific event. When a specific event is occurred, the interactive e-map surveillance system is able to automatically inform the responsible units. When a specific event is occurred, the interactive e-map surveillance system and method of the present invention is able to automatically turn on the emergency equipment.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An e-map surveillance method, comprising:
displaying a map and a plurality of monitoring locations on a screen, wherein the map is corresponding to a monitored area;
displaying emergency messages of a specific event on the screen when one of the monitoring locations detects the specific event; and
automatically informing a unit in charge of the specific event.

2. The e-map surveillance method of claim 1, wherein each the monitoring location is corresponding to a camera, wherein if the specific event is an invader appearing, the camera tracks and captures the invader.

3. The e-map surveillance method of claim 2, further comprising:
determining a move direction for the invader; and
informing next camera to keep tracking the invader according to the move direction.

4. The e-map surveillance method of claim 2, further comprising:
displaying a picture monitored by the camera on the screen when the invader is appeared.

5. The e-map surveillance method of claim 1, wherein the emergency messages of the specific event include a name of the units, a method of communication and useful equipment.

6. The e-map surveillance method of claim 1, further comprising:
automatically turning on a corresponding emergency equipment when the specific event is detected by one of the monitoring locations.

7. The e-map surveillance method of claim 6, wherein the emergency equipment includes at least one lock, at least one fire extinguisher, at least one lighting or at least one power.

8. The e-map surveillance method of claim 1, wherein the step of automatically informing the unit in charge of the specific event comprising automatically dialing to the unit, automatically send out a warning message to the unit or automatically send out an e-mail to the unit.

9. The e-map surveillance method of claim 1, further comprising:
displaying a warning message on the screen when the specific event is detected by one of the monitoring locations.

10. The e-map surveillance method of claim 9, wherein the warning message includes an alarm ringing or a glittering picture.

11. An interactive e-map surveillance system, comprising:
a screen for displaying a map and a plurality of monitoring locations, wherein the map is corresponding to a monitored area;
a host, wherein the host shows emergency messages of a specific event on the screen when the specific event is detected by one of monitoring locations, and
a selection device, wherein the surveillance system informs a unit in charge of the specific event when the specific event is detected by one of monitoring locations and the selection device is activated.

12. The interactive e-map surveillance system of claim 11, wherein each the monitoring location is corresponding to a camera, wherein if the specific event is an invader appearing, the camera tracks and captures the invader.

13. The interactive e-map surveillance system of claim 12, wherein the host determines a move direction for the invader and informs next camera to keep tracking the invader according to the move direction.

14. The interactive e-map surveillance system of claim 12, wherein the host displays a picture monitored by the camera on the screen when the invader is appeared.

15. The interactive e-map surveillance system of claim 11, wherein the emergency messages of the specific event includes a name of the units, a method of communication and useful equipment.

16. The interactive e-map surveillance system of claim 11, wherein the selection device includes a picture of button and the selection device will be activated when the picture of button is pushed down.

17. The interactive e-map surveillance system of claim 11, wherein the host turns on a corresponding emergency equipment when the specific event is detected by one of the monitoring locations and the selection device is activated.

18. The interactive e-map surveillance system of claim 17, wherein the emergency equipment includes at least one lock, at least one fire extinguisher, at least one lighting or at least one power.

19. The interactive e-map surveillance system of claim 11, wherein when the selection device is activated, the host dials to the unit, the host sends out a warning message to the unit or the host sends out an e-mail to the unit.

20. The interactive e-map surveillance system of claim 11, wherein the host displays a warning message on the screen when the specific event is detected by one of the monitoring locations.

21. The interactive e-map surveillance system of claim 20, wherein the warning message includes an alarm ringing or a glittering picture.
